(19) United States
(12) Patent Application Publication
(10) Pub. No.: US 2026/0066201 A1
(43) Pub. Date: Mar. 5, 2026

(54) SAFETY PRESSURE SWITCH

(71) Applicant: ASM IP Holding B.V., Almere (NL)

(72) Inventors: Pilla Anand Raju, Tokyo (JP); Mark Fessler, Phoenix, AZ (US)

(21) Appl. No.: 19/311,156

(22) Filed: Aug. 27, 2025

Related U.S. Application Data
(60) Provisional application No. 63/689,563, filed on Aug. 30, 2024.

(51) Int. Cl. H01H 35/26

(52) U.S. Cl. CPC H01H 35/26

(57) ABSTRACT

A safety pressure switch is presented. For avoiding pressure switch malfunction, the present disclosure presents a safety pressure switch comprising: a container shaped as a cylinder, the container comprising a fuse room comprising a fuse socket, a switch room, and a separator comprises a hole; a pressure switch disposed in the switch room; a fuse disposed in the fuse socket; and a first electrical line and a second electrical line connected to the pressure switch through the hole, wherein the separator separates the fuse room and the switch room, and wherein the hole connects the fuse room and the switch room, and wherein the fuse is installed in the first electrical line.

### CROSS-REFERENCE TO RELATED APPLICATIONS

This application claims priority to U.S. Provisional Patent Application Ser. No. 63/689,563 filed Aug. 30, 2024 titled SAFETY PRESSURE SWITCH, the disclosure of which is hereby incorporated by reference in its entirety.

### FIELD OF INVENTION

The present disclosure relates generally to a pressure switch, more particularly to a pressure switch with safety features to avoid malfunction of the pressure switch used in many areas including substrate processing apparatus.

### BACKGROUND OF THE DISCLOSURE

Pressure switches are generally used for interlocking. Normal pressure switch operates with a relay with a particular current rating.

Whenever pressure reading in the pressure switch increased the cutoff limit, it signals the relay to turn off thereby actuating the interlock with this cutoff signal. Sometimes due to over current the terminals of the relay melts and provides a continuity between terminals even if the relay turns off the signal is still on thereby unaffecting the interlocking system, which can be a safety risk.

Therefore, the present disclosure provides a new pressure switch with safety features to protect the relay terminals from melting.

### SUMMARY OF THE DISCLOSURE

This summary is provided to introduce a selection of concepts in a simplified form. These concepts are described in further detail in the detailed description of example embodiments of the disclosure below. This summary is not intended to identify key features or essential features of the claimed subject matter, nor is it intended to be used to limit the scope of the claimed subject matter.

In accordance with one embodiment there may be provided, a pressure switch structure comprising a container shaped as a cylinder, the container comprising a fuse room comprising a fuse socket, a switch room, and a separator comprises a hole; and a fuse disposed in the fuse socket, wherein the separator separates the fuse room and the switch room, and wherein the hole connects the fuse room and the switch room.

In accordance with another embodiment there may be provided, a safety pressure switch comprising: a container shaped as a cylinder, the container comprising a fuse room comprising a fuse socket, a switch room, and a separator comprises a hole; a pressure switch disposed in the switch room; a fuse disposed in the fuse socket; and a first electrical line and a second electrical line connected to the pressure switch through the hole, wherein the separator separates the fuse room and the switch room, and wherein the hole connects the fuse room and the switch room, and wherein the fuse is installed in the first electrical line.

In an aspect, the pressure switch is an electrical pressure switch.

In an aspect, the fuse tripped when a current flow on the fuse exceeds a threshold current value.

In an aspect, the pressure switch keeps turned on when an applied pressure is less than a threshold pressure.

In an aspect, the pressure switch turned off when an applied pressure exceeds a threshold pressure.

In an aspect, the pressure switch is a mechanical pressure switch, and the mechanical pressure switch comprises a spring and a knob.

In an aspect, the fuse is tripped when a current flowing on the fuse exceeds a threshold current value.

In an aspect, the pressure switch turned on when an applied pressure on the knob is greater than a restoring force of the spring.

In an aspect, the pressure switch turned off when an applied pressure on the knob is lower than a restoring force of the spring.

In an aspect, the fuse room further comprises an alarm unit configured to display an indication when the fuse is tripped.

In an aspect, the container is made from highly insulating materials such as plastics.

### BRIEF DESCRIPTION OF THE DRAWING FIGURES

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

FIG. 1 illustrates an overview of the pressure switch structure according to an embodiment of the present disclosure.

FIG. 2 (a) illustrates an exemplary malfunctioning electrical pressure switch view of a prior art and (b) illustrates an exemplary malfunctioning electrical pressure switch view of a prior art

FIG. 3 (a) illustrates an exemplary electrical pressure switch view according to an embodiment of the present disclosure and (b) illustrates an exemplary electrical pressure switch view when fuse is tripped according to an embodiment of the present disclosure.

FIG. 4 (a) illustrates an exemplary mechanical pressure switch view of a prior art and (b) illustrates an exemplary mechanical pressure switch view of a prior art.

FIG. 5 (a) illustrates an exemplary malfunctioning mechanical pressure switch view of a prior art and (b) illustrates an exemplary malfunction mechanical pressure switch view of a prior art.

FIG. 6 (a) illustrates an exemplary mechanical pressure switch view according to an embodiment of the present disclosure and (b) illustrates an exemplary mechanical pressure switch view when fuse is tripped according to an embodiment of the present disclosure.

FIG. 7 (a) illustrates a perspective view of a pressure switch structure according to an embodiment of the present disclosure and (b) illustrates a functional view of a pressure switch structure according to an embodiment of the present disclosure.

### DETAILED DESCRIPTION OF EXEMPLARY EMBODIMENTS

Although certain embodiments and examples are disclosed below, it will be understood by those in the art that the invention extends beyond the specifically disclosed embodiments and/or uses of the invention and obvious modifications and equivalents thereof. Thus, it is intended that the scope of the invention disclosed should not be limited by the particular disclosed embodiments described below.

As used herein, the term “substrate” may refer to any underlying material or materials, including any underlying material or materials that may be modified, or upon which, a device, a circuit, or a film may be formed. The “substrate” may be continuous or non-continuous; rigid or flexible; solid or porous; and combinations thereof. The substrate may be in any form, such as a powder, a plate, or a workpiece. Substrates in the form of a plate may include wafers in various shapes and sizes. Substrates may be made from semiconductor materials, including, for example, silicon, silicon germanium, silicon oxide, gallium arsenide, gallium nitride and silicon carbide.

As examples, a substrate in the form of a powder may have applications for pharmaceutical manufacturing. A porous substrate may comprise polymers. Examples of workpieces may include medical devices (for example, stents and syringes), jewelry, tooling devices, components for battery manufacturing (for example, anodes, cathodes, or separators) or components of photovoltaic cells, etc.

A continuous substrate may extend beyond the bounds of a process chamber where a deposition process occurs. In some processes, the continuous substrate may move through the process chamber such that the process continues until the end of the substrate is reached. A continuous substrate may be supplied from a continuous substrate feeding system to allow for manufacture and output of the continuous substrate in any appropriate form.

Non-limiting examples of a continuous substrate may include a sheet, a non-woven film, a roll, a foil, a web, a flexible material, a bundle of continuous filaments or fibers (for example, ceramic fibers or polymer fibers). Continuous substrates may also comprise carriers or sheets upon which non-continuous substrates are mounted.

The illustrations presented herein are not meant to be actual views of any particular material, structure, or device, but are merely idealized representations that are used to describe embodiments of the disclosure.

The particular implementations shown and described are illustrative of the invention and its best mode and are not intended to otherwise limit the scope of the aspects and implementations in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationship or physical connections may be present in the practical system, and/or may be absent in some embodiments.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. Thus, the various acts illustrated may be performed in the sequence illustrated, in other sequences, or omitted in some cases.

The subject matter of the present disclosure includes all novel and nonobvious combinations and subcombinations of the various processes, systems, and configurations, and other features, functions, acts, and/or properties disclosed herein, as well as any and all equivalents thereof.

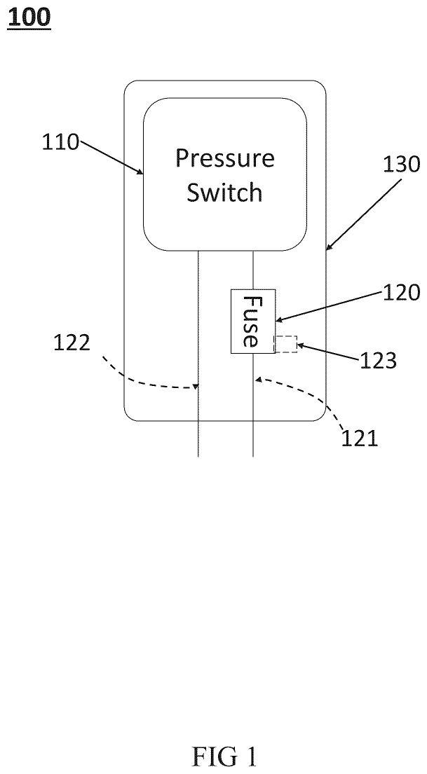

FIG. 1 illustrates a functional view of a safety pressure switch structure according to an embodiment of the present disclosure.

A safety pressure switch structure 100 may comprise a pressure switch 110, a container 130, a fuse 120, a second electrical line 122, and a first electrical line 121. The fuse 120 may be connected in the first electrical line 121. For checking up whether the fuse 120 works well, the structure 100 may further comprise an alarm unit 123.

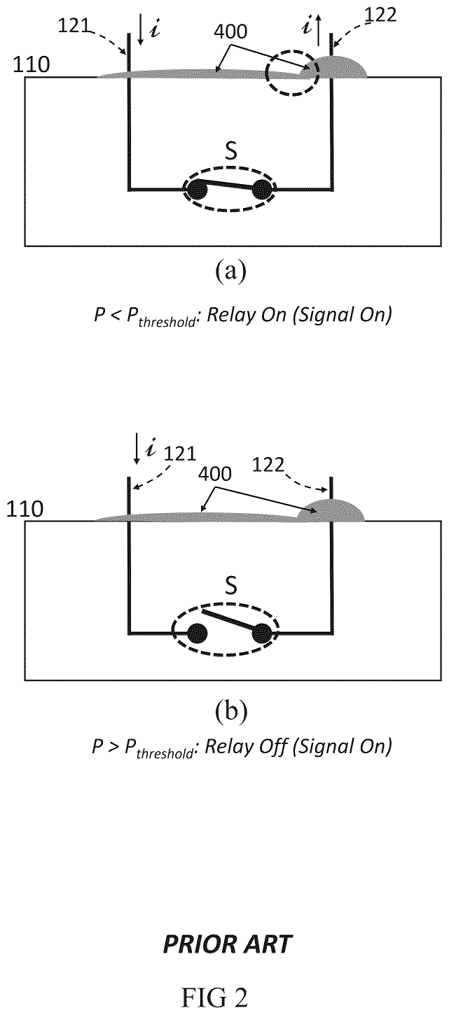

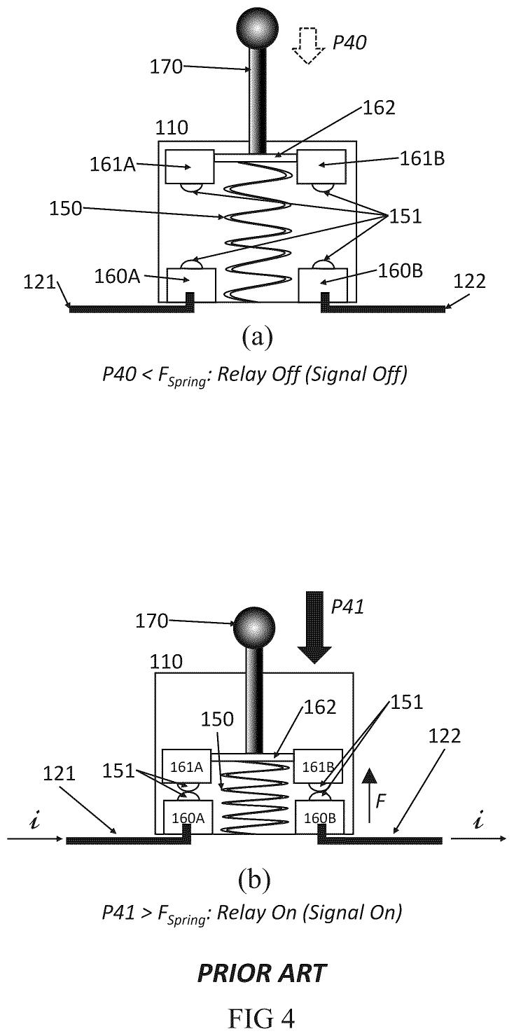

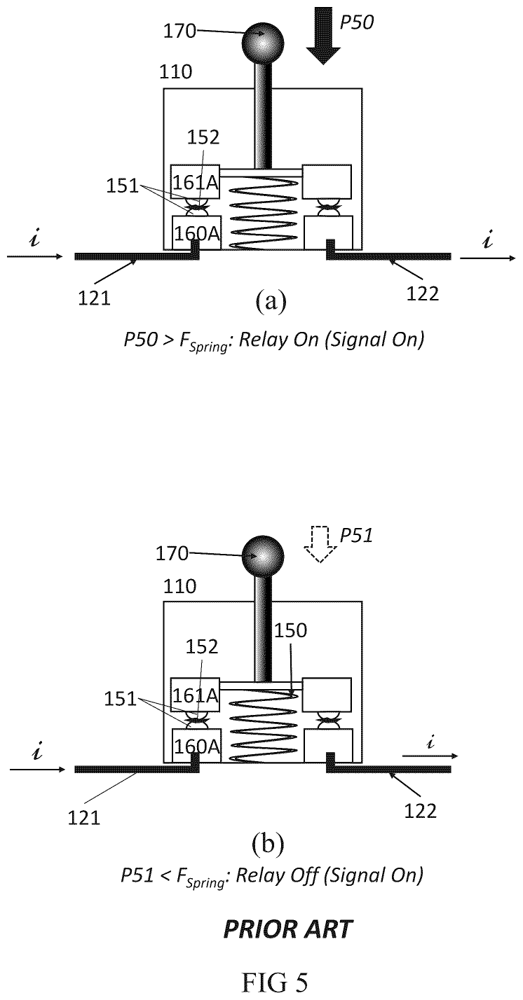

The pressure switch 110 may have different types. FIGS. 2 & 3 illustrate an electrical pressure switch type and FIGS. 4, 5 & 6 illustrate a mechanical pressure switch type.

FIG. 2 (a) & (b) illustrate how an electrical type pressure switch works in prior art.

As illustrated in FIG. 2 (a), when the pressure P applied on the switching circuit S is less than a predetermined threshold pressure P(threshold), the circuit relay signal is on and the signal (current) is on too. It means that the current i in the line 121 gets out through the line 122 in the pressure switch 110. At this moment, suppose that the joint material 400 used to fix the lines 121, 122 to the pressure switch 110 melts down due to heat generated at the line 121 from the current i. In this case the joint material 400 contacting the line 121 may be spread away as showing in FIG. 2 (a). The joint material at the line 121 would be short-circuited to the joint material 400 at the line 122.

Due to the short-circuit formed by the joint material 400, the relay is off when the pressure P applied on the switching circuit S exceeds the threshold pressure P(threshold) but the signal of line 122 is on with current i and this is a faulty condition.

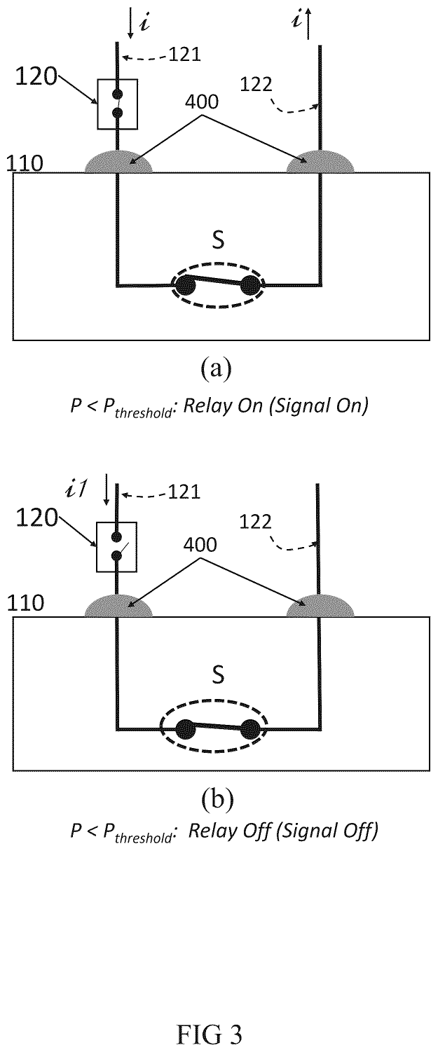

FIG. 3 (a) and (b) illustrate how the present disclosure works at the faulty condition.

As shown in FIG. 3 (a), a fuse 120 may be installed in the first line 121 and initially the fuse 120 may not be tripped. If the fuse 120 is not tripped, the line 121 works as usual and the current i in the line 121 is the same as the current i in the line 122. As the pressure P applied to the switching circuit S is less than a threshold pressure P(threshold), the pressure switch 110 works normally.

However, when the pressure P applied to the switching circuit S is less than the threshold pressure P(threshold) as shown in FIG. 3 (b), the switching circuit S gets closed. However, if the current i1 flowing to the fuse 120 is greater than a threshold current value and the fuse 120 tripped as shown in the figure. Therefore, the whole circuit is open and no current flows in the line 122 resulting in pressure switch protection.

FIG. 4 (a) and (b) illustrate how a mechanical pressure switch works in normal conditions.

The pressure switch 110 comprises a knob 170, a spring 150, a pair of contact bodies (161A, 161B), a connector 162 connecting the contact bodies (161A, 161B), anchors (160A, 160B), and the terminals 151 attached to each of the contact bodies (161A, 161B) and anchors (160A, 160B). The lines 121, 122 each connected to the anchors 160A, 160B.

When the pressure P40 is zero, i.e., no pressure is applied, the knob 170 remains still and the circuit is open and no current flows (P40<F(spring)). But if the pressure P41 exceeds the restoring force of the spring 150, i.e., P41>F(spring), the circuit from the line 121, the anchor 160A, the terminals 151, the contact body 161A, the connector 162, contact body 161B, terminals 151, anchor 160B and the line 122 is closed and current i may flow.

However, if the heat from the current i melts the contacting terminals 151 and they get stuck to each other like the melting area 152 in FIG. 5 (a), then the circuit does not open even when the pressure P51 becomes zero and the restoring force of the spring 150 as shown in FIG. 5 (b). This is similar to the condition of electrical pressure switch's faulty condition illustrated in FIG. 2 (a) and (b).

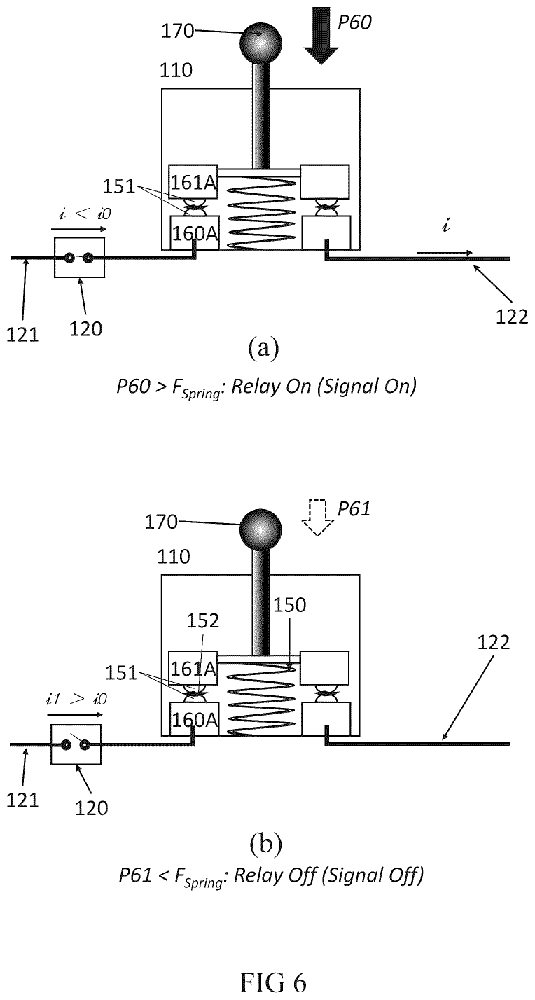

To prevent this faulty condition from happening and to protect the pressure switch, FIG. 6 (a) and (b) illustrate how the present disclosure may work.

The fuse 120 may be installed in the line 121 and with the pressure P60 applied (pressure P60 is greater than the restoring force of the spring 150), the current i may flow through the fuse 120 (if the current i is less than a threshold current value i0) and through the closed circuit in the pressure switch 110 and gets out in the line 122 as shown in the FIG. 6 (a).

However, if the terminals 151 may be melt and attached to each other (152) as shown in FIG. 6 (b), the current i1 flowing in the fuse 120 may be exceeding a threshold current value i0. At this time, the fuse 120 may be tripped as shown and the whole circuit in the pressure switch 110 may be open so that there is no current flowing in the line 122.

FIG. 3 (b) and FIG. 6 (b) illustrate how the present disclosure may protect a pressure switch from malfunction.

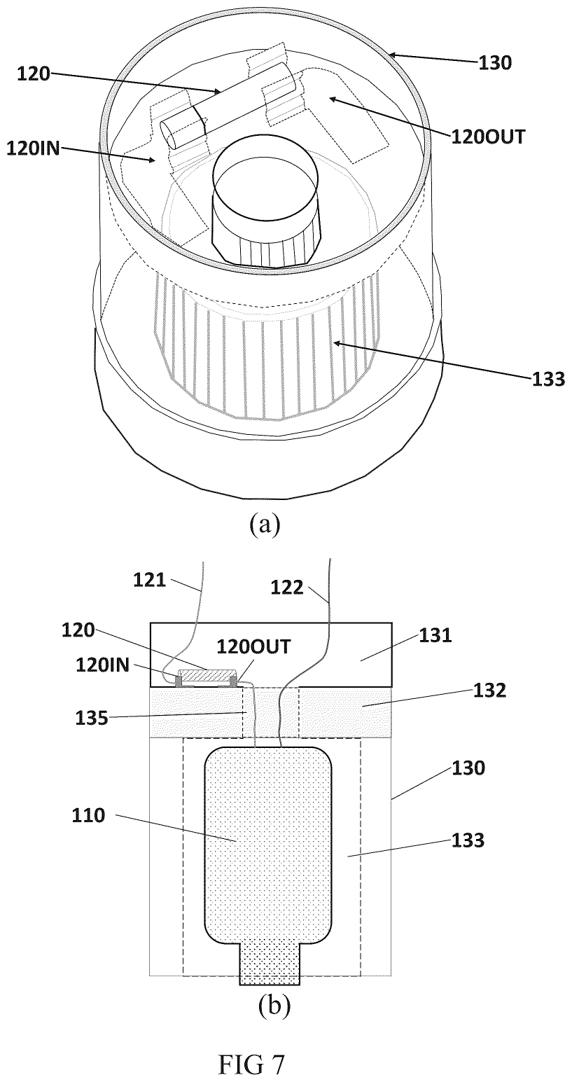

FIG. 7 (a) & (b) illustrate perspective view & side view of an example according to an embodiment of the present disclosure.

A container 130 shaped as a cylinder and a fuse 120 installed in the container and a switch room 133 for pressure switch. The container 130 may be made from highly A more detailed view is shown in FIG. 7 (b).

The container 130 may comprise a fuse room 131, a switch room 133, a separator 132. The container 130 may also comprise a fuse 120 put into a fuse socket (120IN, 120OUT). Socket 120IN is connected to a first electrical line 121 carrying a current and socket 120OUT is connected to a pressure switch 110 in the switch room 133. A second electrical line 122 may carry a current from the pressure switch 110. The fuse room 131 and switch room 133 may be separated by the separator 132 and the first and second electrical line 121, 122 go through a hole 135 which connect the fuse room 131 and switch room 133.

The above-described arrangements of apparatus are merely illustrative of applications of the principles of this invention and many other embodiments and modifications may be made without departing from the spirit and scope of the invention as defined in the claims. The scope of the invention should, therefore, be determined not with reference to the above description, but instead should be determined with reference to the appended claims along with their full scope of equivalents.

1. A pressure switch structure, the structure comprises:
a container shaped as a cylinder, the container comprising a fuse room comprising a fuse socket, a switch room, and a separator comprises a hole; and
a fuse disposed in the fuse socket,
wherein the separator separates the fuse room and the switch room, and wherein the hole connects the fuse room and the switch room.

2. A safety pressure switch, the switch comprising:
a container shaped as a cylinder, the container comprising a fuse room comprising a fuse socket, a switch room, and a separator comprises a hole;
a pressure switch disposed in the switch room;
a fuse disposed in the fuse socket; and
a first electrical line and a second electrical line connected to the pressure switch through the hole, wherein the separator separates the fuse room and the switch room, and wherein the hole connects the fuse room and the switch room, and wherein the fuse is installed in the first electrical line.

3. The safety pressure switch according to claim 2, wherein the pressure switch is an electrical pressure switch.

4. The safety pressure switch according to claim 3, wherein the fuse tripped when a current flowing on the fuse exceeds a threshold current value.

5. The safety pressure switch according to claim 3, wherein the pressure switch keeps turned on when an applied pressure is less than a threshold pressure.

6. The safety pressure switch according to claim 3, wherein the pressure switch turned off when an applied pressure exceeds a threshold pressure.

7. The safety pressure switch according to claim 2, wherein the pressure switch is a mechanical pressure switch, and the mechanical pressure switch comprises a spring and a knob.

8. The safety pressure switch according to claim 7, wherein the fuse is tripped when a current flowing on the fuse exceeds a threshold current value..

9. The safety pressure switch according to claim 7, wherein the pressure switch turned on when an applied pressure on the knob is less than a restoring force of the spring.

10. The safety pressure switch according to claim 7, wherein the pressure switch turned off when an applied pressure on the knob is lower than a restoring force of the spring.

11. The safety pressure switch according to claims 3, wherein the fuse room further comprises an alarm unit configured to display an indication when the fuse is tripped.

12. The safety pressure switch according to claim 2, wherein the container is made from highly insulating materials such as plastics.
